(19) United States
(12) Patent Application Publication
(10) Pub. No.: US 2017/0136653 A1
(43) Pub. Date: May 18, 2017

(54) Mold for Making Units of a Dome Structure and Method of Using the Same

(71) Applicant: Xiaoping SUN, Jiangsu (CN)

(72) Inventor: Xiaoping SUN, Allen, TX (US)

(21) Appl. No.: 14/646,977

(22) PCT Filed: Apr. 15, 2015
(86) PCT No.: PCT/CN2015/076623

§ 371 Date: May 22, 2015

(51) Int. Cl. B28B 7/00; B29C 45/26; A63H 33/14; B29C 45/40; E04B 1/32; B29C 33/30; B28B 1/24

(52) U.S. Cl. CPC B28B 7/0029; B29C 33/302; B29C 45/26; B28B 1/24; B29C 45/40; E04B 1/3211; A63H 33/14; B29L 2031/10

(57) ABSTRACT

Described herein is a mold for making units of a dome structure, comprising: a first mold piece, a second mold piece, a third mold piece; the third mold piece is configured to be sandwiched between and assembled with the first and second mold pieces; wherein an assembly of the first mold piece, the second mold piece, and the third mold piece is configured to form a mold cavity; wherein the third mold piece comprises a plurality of sidewall plates; wherein the plurality of sidewall plates are perpendicular to a same spherical surface when the third mold piece is assembled with the first and second mold pieces. Described herein is also a method of using the mold, and the method comprises: assembling the plurality of sidewall plates to form the third mold piece; assembling the second mold piece and the third mold piece; assembling the first mold piece with the second mold piece and the third mold piece to form the mold cavity of a first-level mold; injecting a molding material into the mold cavity; forming a unit of a first-level dome structure by allowing the molding material to form into shape; opening the first-level mold; extracting the unit of the first-level dome structure.

### TECHNICAL FIELD

The present disclosure relates to a mold for making units of a dome structure and method of using the same.

### BACKGROUND

A structure that resembles a hemisphere or the hollow upper half of a sphere is often referred to as a dome. Dome structures made of various materials have a long architectural lineage. Their prevalence in use has resulted in many types and variations, such as an onion dome, corbel dome, geodesic dome, oval dome, polygonal dome, sail dome, saucer dome, umbrella dome, etc.

Emergency shelters are structures built for residence and dwelling during or after a manmade or natural disaster, such as a fire, flood, tornado or earthquake. In some disasters such as tornados, survival depends heavily on the mechanical strength and quality of the emergency shelters. Temporary emergency shelters available on the market that are adaptable to individual use, such as inexpensive tents, lack the necessary strength, durable quality, and environmental conformability for survival during a natural disaster. Emergency shelters that overcome some of the disadvantages of temporary shelters are often built primarily for other purposes, such as schools, churches, gymnasiums, etc. They are more expensive and difficult to build, are not practical to be owned by a family, and are sometimes not available at a near distance to a person in need of survival during a disaster situation.

A spherical ball or a round ball is a three dimensional object that has a spherical surface, characterized as a perfectly round geometrical object in a three-dimensional space. A spherical surface has a set of points that are all the same distance, which is referred to as the radius of the sphere or r, from a given point in space. The given point is known as the center of the sphere. The shortest path connecting two points lying entirely in the sphere is a minor arc of the great circle passing the points. On a sphere, a central angle of an arc of a great circle is an angle spanned by the radii from each end of the arc to the center of the sphere. A plane section of a sphere is a circle. A great circle, also known as an orthodrome or Riemannian circle, of a sphere is the intersection of the sphere and a plane which passes through the center point of the sphere, as opposed to a general circle of a sphere where the plane is not required to pass through the center. A sphere may be divided into two equal hemispheres by any plane that passes through its center.

A spherical ball is unique in many ways. For instance, in comparison to other three dimensional objects, a spherical ball has the largest volume for the smallest surface area: the sphere has the smallest surface area among all surfaces enclosing a given volume and it encloses the largest volume among all closed surfaces with a given surface area.

For the reason above, a dome structure resembling a hemisphere may have the benefit of lower consumption of construction materials, lower cost, higher enclosed space for use, higher structural strength and better safety. However, constructing a dome structure is difficult, because one of the greatest hurdles is to provide the structural resemblance to a hemisphere. As such, molds for pre-fabricated units of a dome structure may resolve the problem, and may provide a wide range of applications in fields such as emergency shelters, building constructions or toys.

### SUMMARY

Described herein is a mold for making units of a dome structure, comprising: a first mold piece, a second mold piece, a third mold piece; the third mold piece is configured to be sandwiched between and assembled with the first and second mold pieces; wherein an assembly of the first mold piece, the second mold piece, and the third mold piece is configured to form a mold cavity; wherein the third mold piece comprises a plurality of sidewall plates; wherein the plurality of sidewall plates are perpendicular to a same spherical surface when the third mold piece is assembled with the first and second mold pieces.

According to an embodiment of the mold, the first mold piece comprises a first spherical surface.

According to an embodiment of the mold, each of the plurality of sidewall plates comprises an end surface conforming to the first spherical surface.

According to an embodiment of the mold, the second mold piece comprises a second spherical surface.

According to an embodiment of the mold, each of the plurality of sidewall plates comprises an end surface conforming to the second spherical surface.

According to an embodiment of the mold, a cross section of the mold cavity is an equilateral triangle in shape.

According to an embodiment of the mold, a cross section of the mold cavity is a triangle in shape.

According to an embodiment of the mold, a cross section of the mold cavity is isosceles trapezoid in shape.

According to an embodiment of the mold, the third mold piece comprises three or more sidewall plates.

According to an embodiment of the mold, the mold further comprises a plurality of fasteners configured to join the plurality of sidewall plates with each other.

According to an embodiment of the mold, the mold further comprises a plurality of fasteners configured to join the plurality of sidewall plates with the first mold piece or second mold piece to form the mold cavity.

According to an embodiment of the mold, the plurality of sidewall plates comprise a plurality of through holes.

According to an embodiment of the mold, the second mold piece comprises a plurality positioning holes for joining with the third mold piece.

According to an embodiment of the mold, the plurality positioning holes comprises a first group of four positioning holes that are on a first minor arc of a first great circle of the second spherical surface.

According to an embodiment of the mold, the plurality positioning holes comprises a second group of two positioning holes that are on a second minor arc of a second great circle of the second spherical surface.

According to an embodiment of the mold, the mold further comprises a base that is configured to support an assembly of the first, second and third mold piece.

According to an embodiment of the mold, the mold cavity is configured for receiving a molding material for making units of the dome structure.

According to an embodiment of the mold, the mold further comprises an injection hole for receiving a molding material into the mold cavity.

According to an embodiment, a method of using the mold comprises: assembling the plurality of sidewall plates to form the third mold piece; assembling the second mold piece and the third mold piece; assembling the first mold piece with the second mold piece and the third mold piece to form the mold cavity of a first-level mold; injecting a molding material into the mold cavity; forming a unit of a first-level dome structure by allowing the molding material to form into shape; opening the first-level mold; extracting the unit of the first-level dome structure.

Described herein also is a method of making units of a dome structure using a set of molds, wherein each set of molds are configured for making units of the dome structure; wherein the set of molds comprises a first-level mold; wherein the first-level mold comprises a first mold piece, a second mold piece, and a third mold piece; wherein the third mold piece is configured to be sandwiched between and assembled with the first and second mold pieces; wherein the third mold piece comprises a plurality of sidewall plates; wherein the plurality of sidewall plates are perpendicular to a same spherical surface when the third mold piece is assembled with the first and second mold pieces; wherein the first-level mold comprises an injection hole for receiving a molding material into the mold cavity; wherein the method comprising: assembling the plurality of sidewall plates to form the third mold piece; assembling the second mold piece and the third mold piece; assembling the first mold piece with the second mold piece and the third mold piece to form the mold cavity of the first-level mold; injecting the molding material into the mold cavity; forming a unit of a first-level dome structure by allowing the molding material to form into shape; opening the first-level mold; extracting the unit of a first-level dome structure.

### BRIEF DESCRIPTION OF FIGURES

FIG. 1A is a perspective view of a first mold piece according to an embodiment; FIG. 1B is a top view thereof; and FIG. 1C is a front view thereof.

FIG. 2A is a perspective view of a second mold piece according to an embodiment; FIG. 2B is a top view thereof; and FIG. 2C is a front view thereof.

FIG. 3A is a perspective view of an assembly of a first mold piece, a second mold piece, a third mold piece and a base according to a first embodiment; FIG. 3B is an explosion view thereof; and FIG. 3C is an illustrative view of the third mold piece thereof.

FIG. 4A is a perspective view of an assembly of a first mold piece, a second mold piece, a third mold piece and a base according to a second embodiment; FIG. 4B is an explosion view thereof; and FIG. 4C is an illustrative view of the third mold piece thereof.

FIG. 5A is a perspective view of a sidewall plate according to an embodiment; FIG. 5B is a top view thereof; and FIG. 5C is a front view thereof.

FIG. 6A is a perspective view of a fastener or screw Q according to an embodiment; FIG. 6B is a top view thereof; and FIG. 6C is a front view thereof.

FIG. 7A is a perspective view of a fastener or screw S according to an embodiment; FIG. 7B is a top view thereof; and FIG. 7C is a front view thereof.

FIG. 8A is a perspective view of a fastener or screw T according to an embodiment; FIG. 8B is a top view thereof; and FIG. 8C is a front view thereof.

FIG. 9A is a perspective view of a base according to a first embodiment; FIG. 9B is a top view thereof; and FIG. 9C is a front view thereof.

FIG. 10A is a perspective view of a base according to a second embodiment; FIG. 10B is a top view thereof; and FIG. 10C is an illustrative view of an extension of the sidewall of the base.

FIG. 11 is a flow chart of a method using the mold as described herein.

FIG. 12 is an illustrative view of a dome structure comprising spherical triangular units made from the mold according to an embodiment as shown in FIG. 3.

FIG. 13 is a schematic showing of the spatial relations of units of a dome structure.

FIG. 14 is a schematic showing of the geometrical relations of the spherical triangular unites for a dome structure during an assembly.

FIG. 15 is an illustrative view of a dome structure comprising spherical isosceles trapezoid units made from the mold according to an embodiment as shown in FIG. 4.

### DETAILED DESCRIPTION

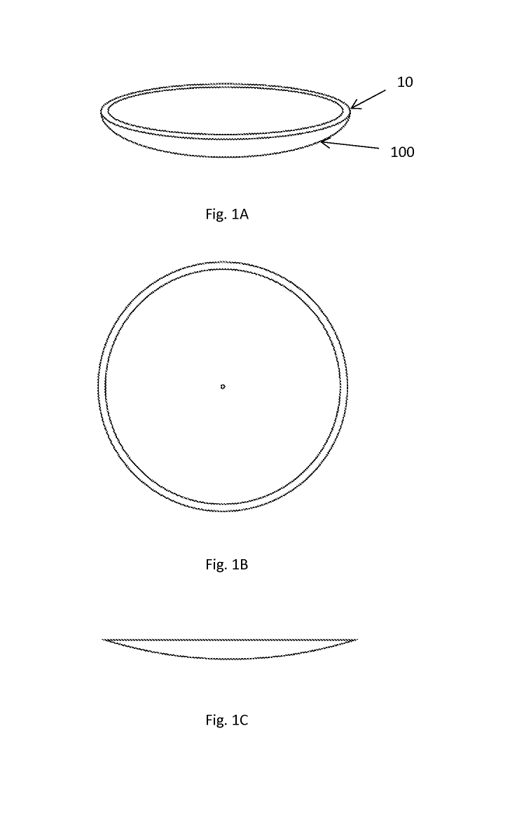

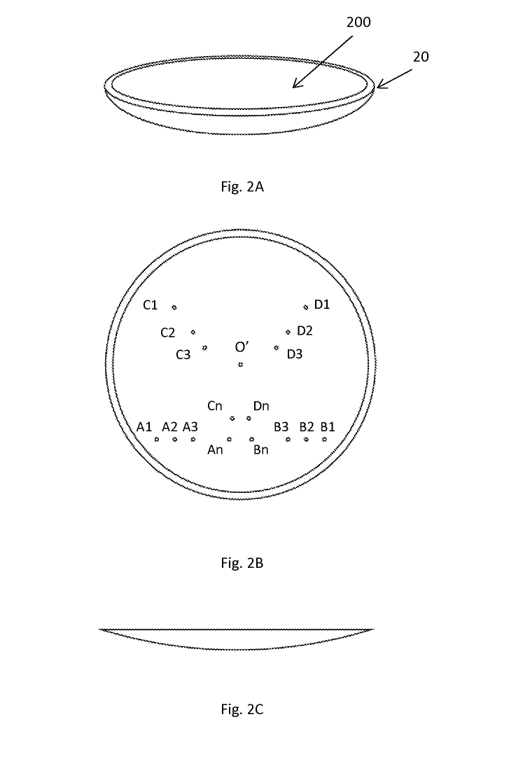

According to an embodiment, a mold for making units of a dome structure comprises a first mold piece 10, a second mold piece 20, and a third mold piece 30. According to an embodiment as shown in FIG. 1A-1C, the first mold piece 10 comprises a first spherical surface 100. According to an embodiment as shown in FIG. 2A-2C, the second mold piece 20 comprises a second spherical surface 200.

According to an embodiment, the first spherical surface is part of a sphere with a radius of r. Preferably, the sphere with radius r may conform with the inner hemisphere of the dome structure.

According to an embodiment, the second spherical surface is part of a sphere with a radius of R. Preferably, the sphere with radius R may conform with the outer hemisphere of the dome structure.

According to an embodiment, r is smaller than R in value.

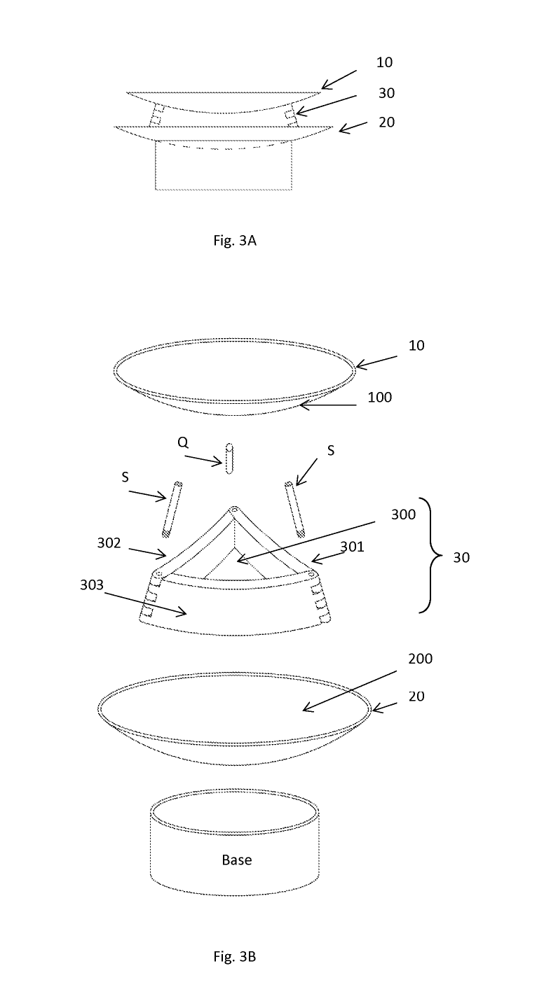

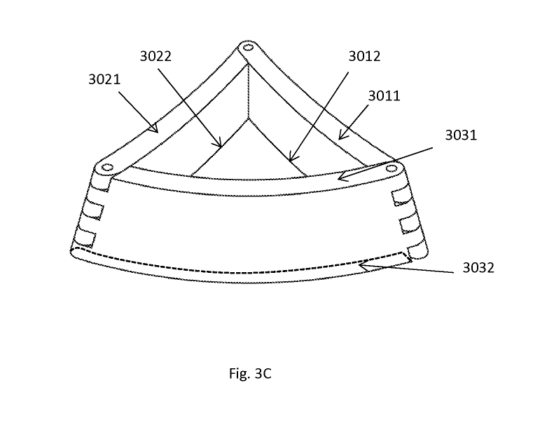

According to an embodiment as shown in FIG. 3A-3C, the third mold piece 30 is configured to be sandwiched between and assembled with the first mold piece 10 and second mold piece 20. An assembly of the first mold piece 10, the second mold piece 20, and the third mold piece 30 is configured to form a mold cavity 300.

As shown in FIG. 3B, according to an embodiment, the third mold piece 30 comprises three sidewall plates 301, 302, and 303. Three sidewall plates 301, 302, and 303 are perpendicular to the first spherical surface 100 and to the second spherical surface 200 when the third mold piece 30 is assembled with the first and second mold pieces 10 and 20.

As shown in FIG. 3C, according to an embodiment, each of the plurality of sidewall plates 301, 302, and 303 respectively comprises a first end surface 3011, 3021, and 3031 conforming to the first spherical surface 100. In addition or in the alternative, each of the plurality of sidewall plates 301, 302, and 303 respectively comprises a second end surface 3012, 3022, and 3032 conforming to the second spherical surface 200.

According to an embodiment, when the plurality of sidewall plates 301, 302, and 303 are the same in size, a cross section of the mold cavity 300 is an equilateral triangle in shape. Alternatively, sidewall plates 301 and 302 may be the same in size and 303 may be different in size from 301 and 302, such that a cross section of the mold cavity 300 may be an isosceles triangle in shape.

As shown in FIG. 4A-4C, according to an embodiment, a mold for making units of a dome structure comprises a first mold piece 11, a second mold piece 21, and a third mold piece 40. The first mold piece 11 comprises a first spherical surface 101. The second mold piece 21 comprises a second spherical surface 201. The third mold piece 40 is configured to be sandwiched between and assembled with the first mold piece 11 and second mold piece 21. An assembly of the first mold piece 11, the second mold piece 21, and the third mold piece 40 is configured to form a mold cavity 400. The third mold piece 40 comprises four sidewall plates 401, 402, 403 and 404 that are perpendicular to the first spherical surface 101 and to the second spherical surface 201 when the third mold piece 40 is assembled with the first and second mold pieces 11 and 21.

As shown in FIG. 4C, according to an embodiment, each of the plurality of sidewall plates 401, 402, 403 and 404 respectively comprises a first end surface 4011, 4021, 4031 and 4041 conforming to the first spherical surface 101. In addition or in the alternative, each of the plurality of sidewall plates 401, 402, 403 and 404 respectively comprises a second end surface 4012, 4022, 4032 and 4042 conforming to the second spherical surface 201. As shown in FIG. 4A-4C, according to an embodiment, a cross section of the mold cavity 400 is an isosceles trapezoid in shape.

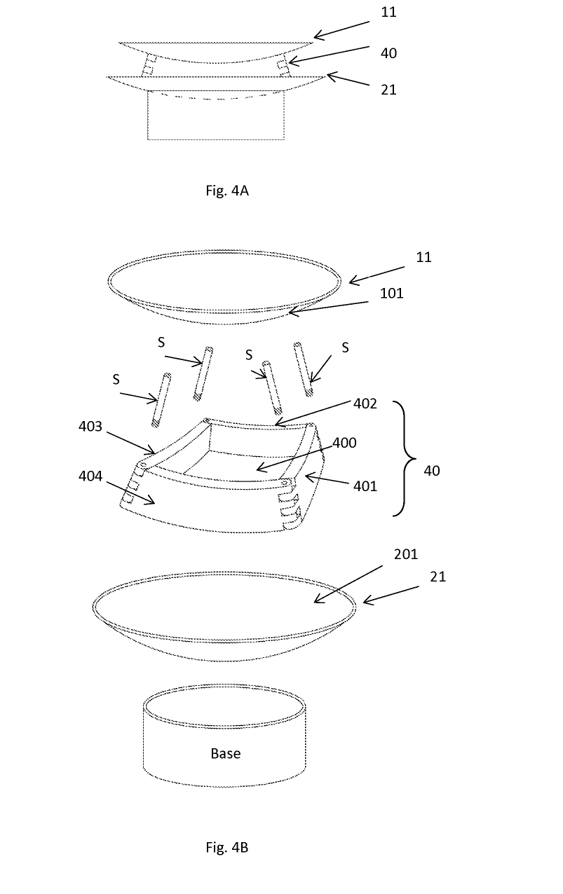

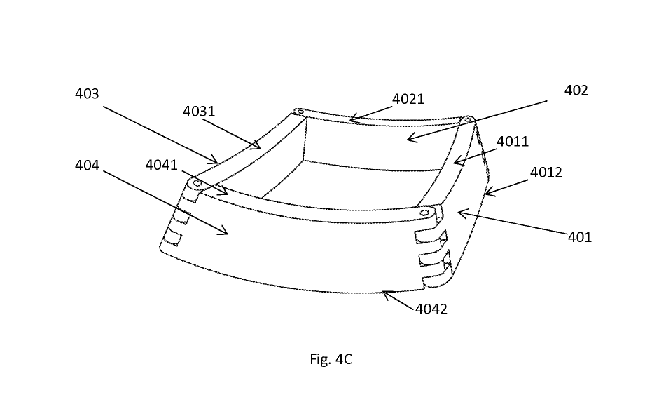

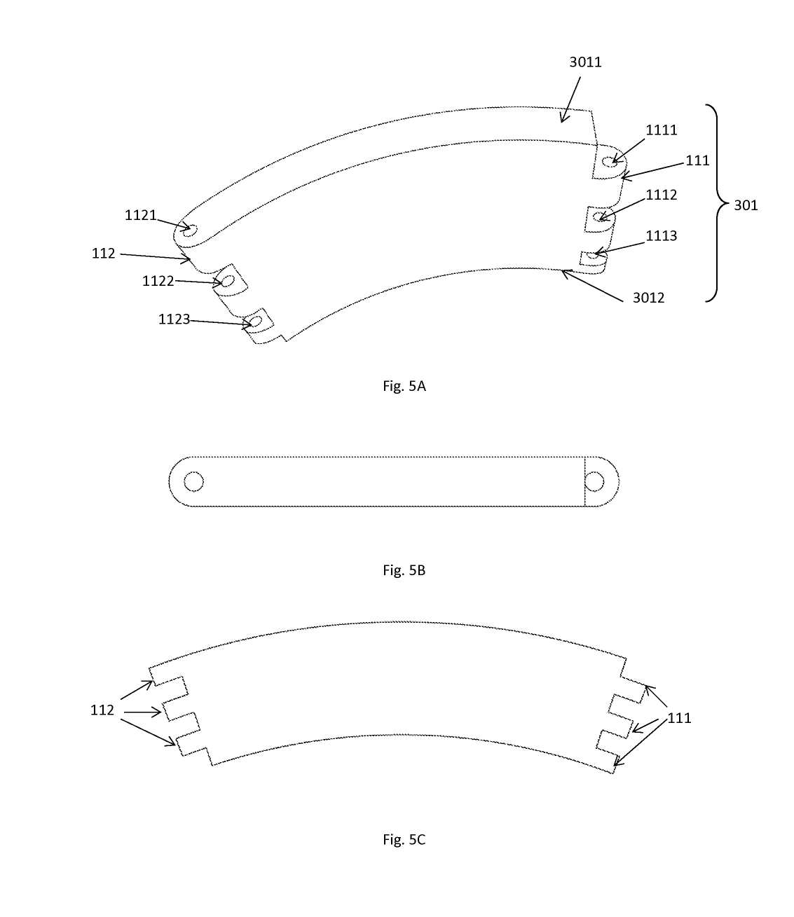

One embodiment of a sidewall plate 301 that may be used in FIG. 3-4 is shown in FIG. 5. As shown in FIG. 5A, a side wall plate 301 comprises a first end surface 3011 and a second end surface 3012, both of which are arc-like and are concentric. As shown in FIG. 5A-5C, the side wall plate 301 further comprises hinges 111 on a third end 3013 and hinges 112 on a forth end 3014 thereof. Hinges such as 111 and 112 are configured for allowing different sidewall plates to be joined together with each other, and/or to be joined with the first mold piece and/or the second mold piece during assembly of the mold.

According to an embodiment, plurality of sidewall plates may comprise a plurality of through holes on the ends of the sidewall plates, which may be configured for receiving fasteners. As shown in FIG. 5A, the side wall plate 301 comprises through holes 1111, 1112, 1113 on the third end 3013 and 1121,1122 and 1123 on the forth end 3014. As shown in FIG. 5B top view, the through holes are aligned on the respective end, for receiving fasteners. As shown in FIG. 5C, the hinge 111 on the third end and the hinge 112 the forth end are designed to be complementary. Preferably a third end of one sidewall plate and a forth end of another sidewall plate are configured to connect or fit with each other for assembly of adjoining sidewall plates.

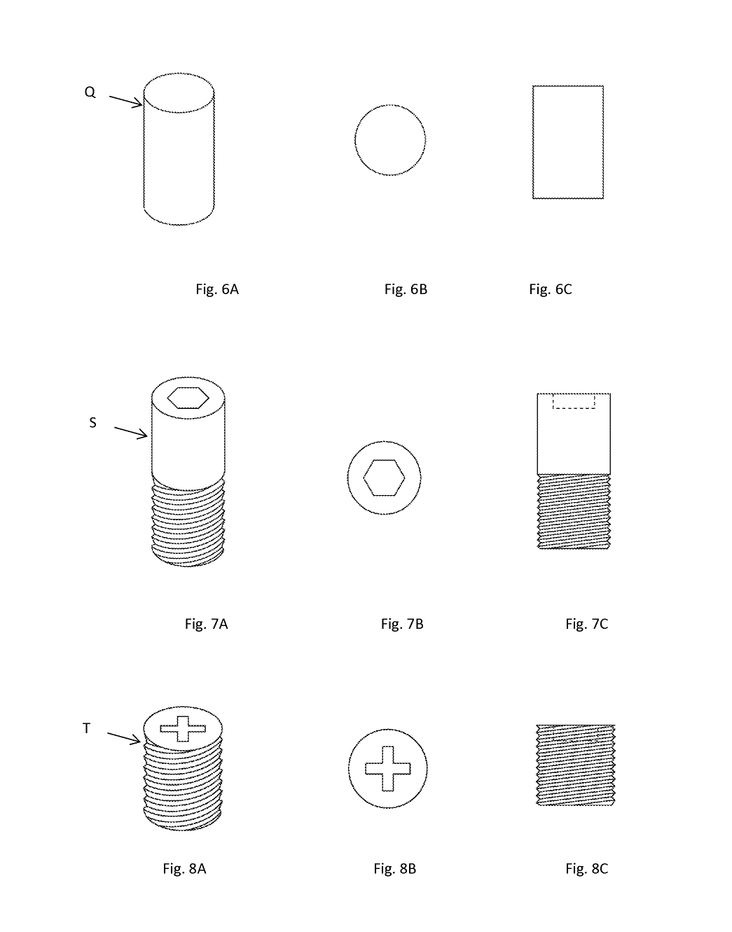

According to an embodiment of the mold, the mold further comprises a plurality of fasteners configured to join the plurality of sidewall plates with each other. As shown in FIG. 3-4, plurality sidewall plates are configured to be interconnected or assembled into a third mold piece by fasteners. Various fasteners may be used for assembly. Example of fasteners may include screws and bolts, such as a fastener or screw Q and/or a fastener or screw S. According to an embodiment as shown in FIG. 6A-C, a screw Q has two smooth heads, and a cylinder body that is configured to fit through the aligned through holes of two adjoining sidewall plates for interconnecting two adjoining sidewall plates. The screw Q need not have external threads.

According to an embodiment as shown in FIG. 7A-C, a screw S has a hex socket head, and a cylinder body that is configured to fit through the aligned through holes of two adjoining sidewall plates for interconnecting two adjoining sidewall plates. The screw S has external threads. In addition for interconnecting two adjoining sidewall plates, the threaded portion of screw S is configured for connecting the plurality of sidewall plates of the third mold piece with the second mold piece and/or the first mold piece, as shown in FIG. 3-4.

According to an embodiment as shown in FIG. 2, the second mold piece may optionally comprise a plurality of positioning holes for positioning and joining with the third mold piece. Fasteners such as screws S may be used to position and assemble the third mold piece with the second mold piece by fastening or securing using the positioning holes. According to an embodiment, the plurality of positioning holes comprises a first group of four positioning holes A1, B1, A2 and B2 that are on a first minor arc of a first great circle of the second spherical surface. The second mold piece may also comprise additional n number of pairs of positioning holes, such as An and Bn, on the same first minor arc of a first great circle of the second spherical surface, wherein n is the number of levels of the dome structure. Each pair of positioning holes is configured for positioning a level specific third mold piece. For example, positioning holes A1 and B1 are configured for positioning a third mode piece for making a first-level spherical triangular unit for a dome structure; positioning holes A2 and B2 are configured for positioning a third mode piece for making a second-level spherical triangular unit for the dome structure; positioning holes An and Bn are configured for positioning a third mode piece for making a n-level spherical triangular unit for the dome structure; wherein n is the number of levels of the dome structure. According to an embodiment, an arc length between A1 and B1 is L1, and expressed as L1=L_{A1,B1}; an arc length between A2 and B2 is L2, and expressed as L2=L_{A2,B2}; an arc length between An and Bn is Ln, and expressed as Ln=L_{An,Bn}. According to an embodiment, pairs of positioning holes A1 and B1, A2 and B2, An and Bn are each symmetrically distributed relative to the O′, the center of the second spherical surface of the second mold piece.

As shown in FIG. 2, the second mold piece may optionally further comprise a second group of two positioning holes C1 and D1 that are on a second minor arc of a second great circle of the second spherical surface. The second mold piece may also comprise additional n number of pairs of positioning holes C2 and D2, and Cn and Dn on the same second minor arc of the second great circle of the second spherical surface, wherein n is the number of levels of the dome structure. The second group of positioning holes is together with the first group of positioning holes to be used for making isosceles trapezoid units of a dome structure. Specifically, Positioning holes A1, B1, C1 and D1 are configured for positioning a third mode piece for making a first-level spherical isosceles trapezoid unit for a dome structure; positioning holes A2, B2, C2, and D2 are configured for positioning a third mode piece for making a second-level spherical isosceles trapezoid unit for the dome structure; positioning holes An, Bn, Cn and Dn are configured for positioning a third mode piece for making a n-level spherical isosceles trapezoid unit for the dome structure; wherein n is the number of levels of the dome structure. According to an embodiment, an arc length between C1 and D1 is L2, and expressed as L2=L_{C1,D1}; an arc length between C2 and D2 is L3, and expressed as L3=L_{C2,D2}; an arc length between Cn and Dn is L(n+1), and expressed as L(n+1)=L_{Cn,Dn}. In addition, L1=L_{C1,A1}=L_{D1,B1}; H2=L_{C2,A2}=L_{D2,B2}; Hn=L_{Dn,Bn}. According to an embodiment, pairs of positioning holes C1 and D1, C2 and D2, Cn and Dn are each symmetrically distributed relative to the O′, the center of second spherical surface of the second mold piece.

According to an embodiment, positioning holes A1, B1, A2, B2, An, Bn, C1, D1, C2, D2, Cn and Dn may comprise internal threads. Such internal threads may mate with a respectively complementary thread of the screws S or other type of screws. Furthermore, optionally, when not in use, some of the positioning holes A1, B1, A2, B2, An, Bn, C1, D1, C2, D2, Cn and Dn may receive a screw T as shown in FIG. 8A-8C which has complementary external threads. A screw T is fully threaded and has no head projecting past the opening of the positioning holes, so that an unused positioning holes are filled in by screws T.

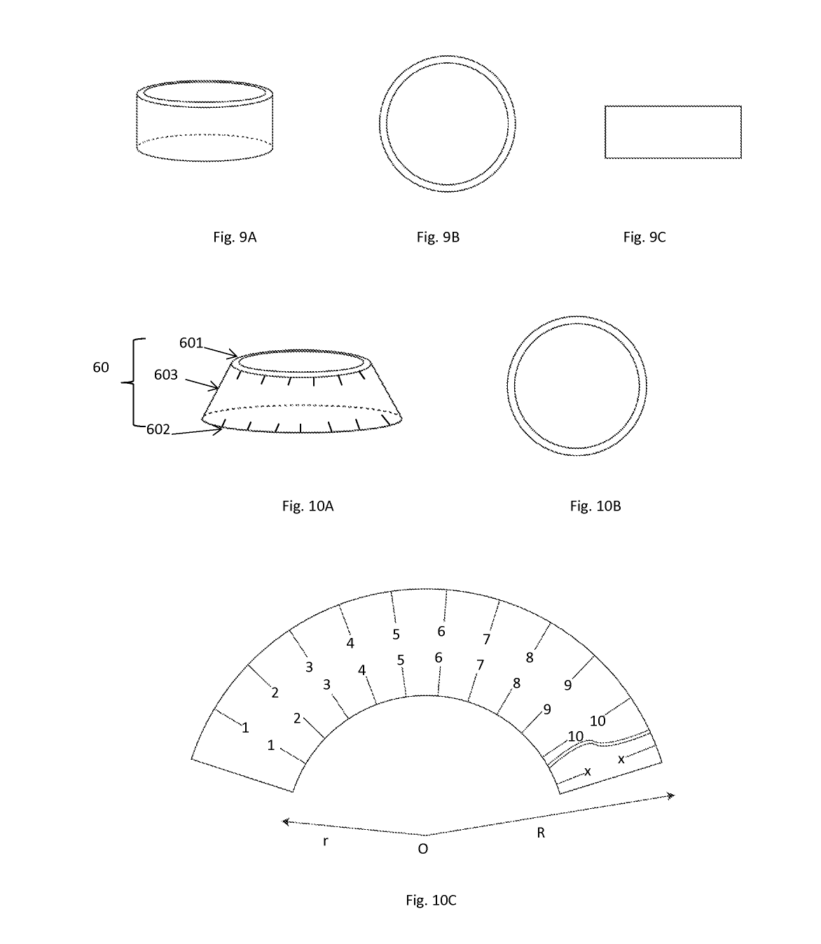

According to an embodiment, the mold may optionally further comprises a base that is configured to support an assembly of the first, second and third mold piece. An embodiment of a base may be a column shaped base shown in FIG. 9, or a frustum shaped base as shown in FIG. 10. A base may be solid or hollow. As shown in FIG. 10, a hollow frustum shaped base 60 has a top edge 601, a bottom edge 602, and sidewall 603. The base 60 is further marked with calibration marks along its edges 601 and 602 on the exterior surface of its sidewall 603. The calibration marks may be used for measurement when the base is laid on the side and rolled. Preferably, the sidewall 603, when extended from side to side into a fan shape, has an inner radius of r and an outer radius of R, as shown in FIG. 10C. Furthermore, preferably, the inner radius of r and the outer radius of R of the base are respectively the inner radius and outer radius of the dome structure to be assembled from the units made from the mold comprising such a base.

In alternative embodiments, the base of the mold may not need to be a separate piece. Rather the second mold piece may have its own support portion built to the bottom thereof. The support portion may be a foot, a leveled base, or a stand etc.

According to an embodiment as shown in FIG. 11, a method of using the mold as described in FIG. 3 or FIG. 4 comprises: assembling the plurality of sidewall plates to form the third mold piece; assembling the second mold piece and the third mold piece; assembling the first mold piece with the second mold piece and the third mold piece to form the mold cavity of a first-level mold; injecting a molding material into the mold cavity; forming a unit of a first-level dome structure by allowing the molding material to form into shape; opening the first-level mold; extracting the unit of the first-level dome structure.

Described herein also is a method of making units of a dome structure using a set of molds, wherein each set of molds are configured for making units of the dome structure; wherein the set of molds comprises a first-level mold; wherein the first-level mold comprises a first mold piece, a second mold piece, and a third mold piece; wherein the third mold piece is configured to be sandwiched between and assembled with the first and second mold pieces; wherein the third mold piece comprises a plurality of sidewall plates; wherein the plurality of sidewall plates are perpendicular to a same spherical surface when the third mold piece is assembled with the first and second mold pieces; wherein the first-level mold comprises an injection hole for receiving a molding material into the mold cavity; wherein the method comprising: assembling the plurality of sidewall plates to form the third mold piece; assembling the second mold piece and the third mold piece; assembling the first mold piece with the second mold piece and the third mold piece to form the mold cavity of the first-level mold; injecting the molding material into the mold cavity; forming a unit of a first-level dome structure by allowing the molding material to form into shape; opening the first-level mold; extracting the unit of a first-level dome structure.

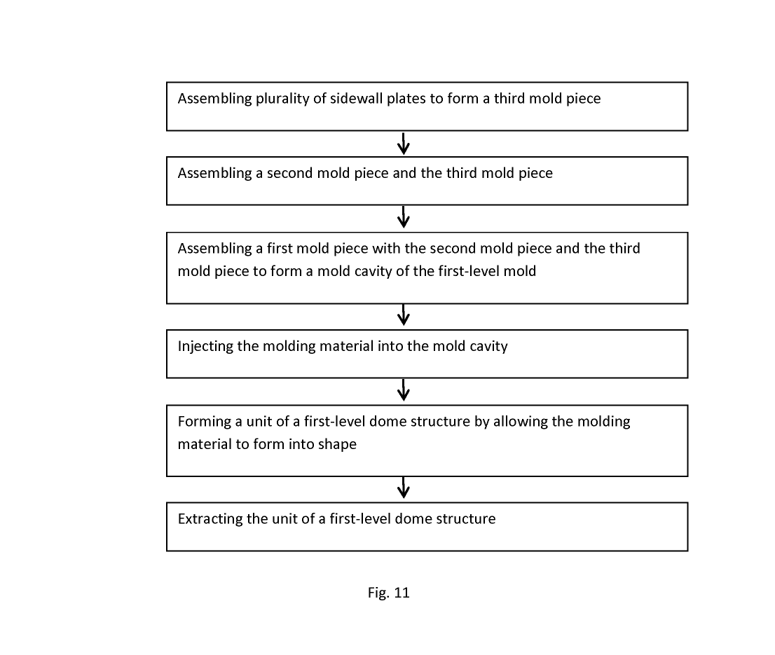

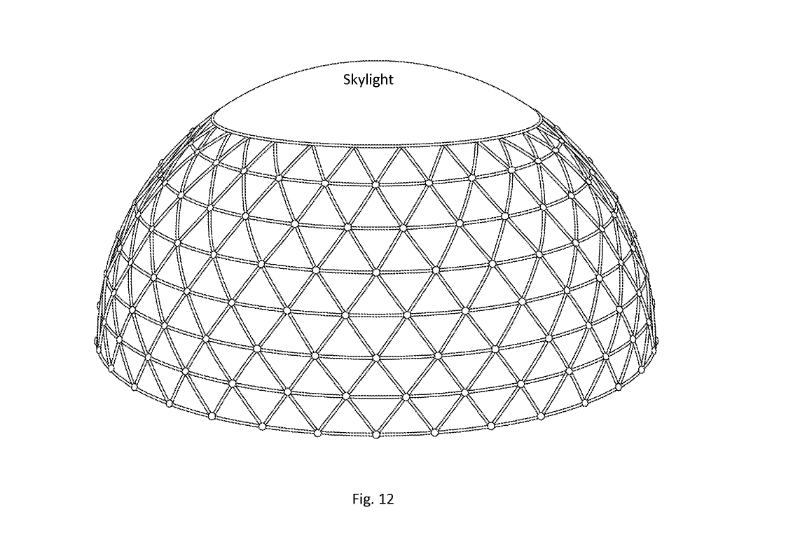

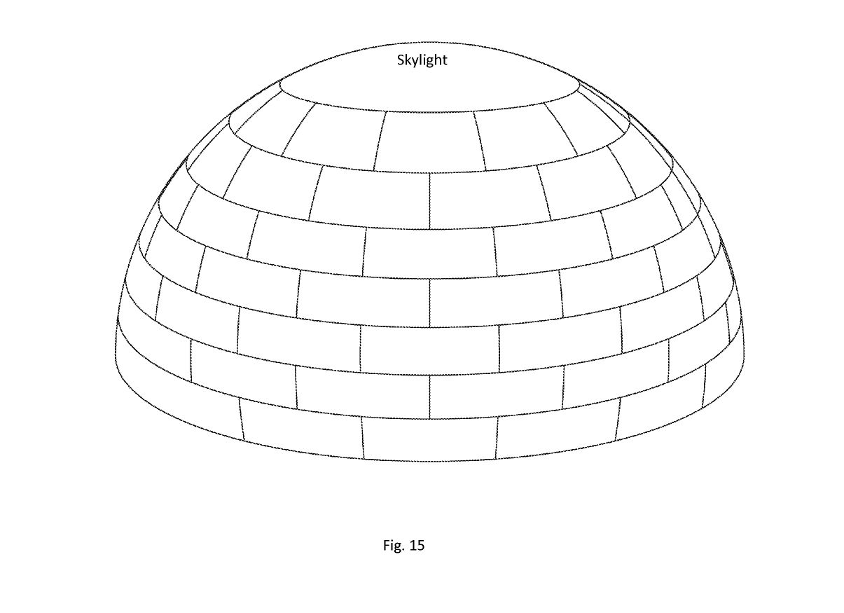

When the dome structure to be made has n number of levels, the set of molds comprise n number of level-specific third mold piece for making units for the n number of levels. Such units may be spherical triangular units, and an example of a dome structure assembled from plurality of level specific spherical triangular units is shown in FIG. 12. Or, such units may be spherical isosceles trapezoid units, and an example of a dome structure assembled from plurality of level specific spherical isosceles trapezoid units is shown in FIG. 15. As used herein, a spherical triangular units or a spherical isosceles trapezoid unit is a unit for a dome structure that is made from the assembled mold described herein.

The assembled dome structure may also comprise skylights at the top of the dome. The assembled dome structure may further comprise windows and entryways when it's to be used as shelters or buildings. Windows or entryway may be designed within special purpose units of the dome structure.

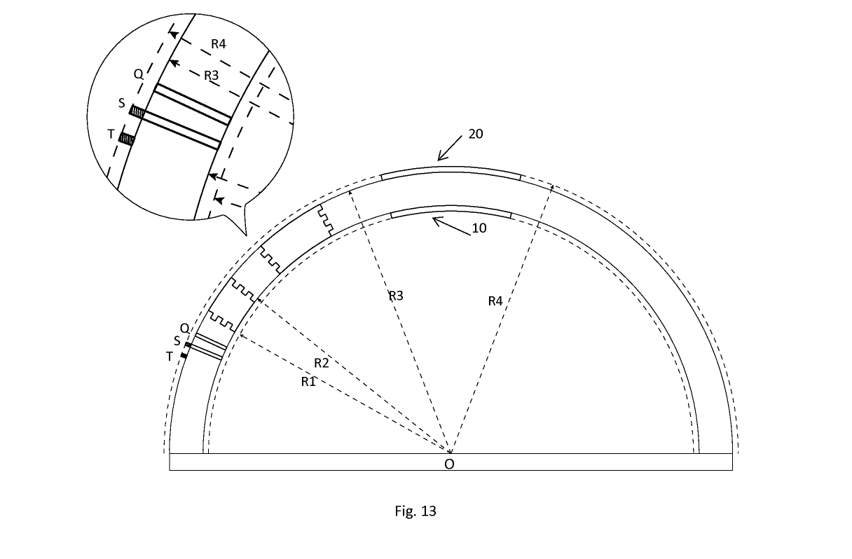

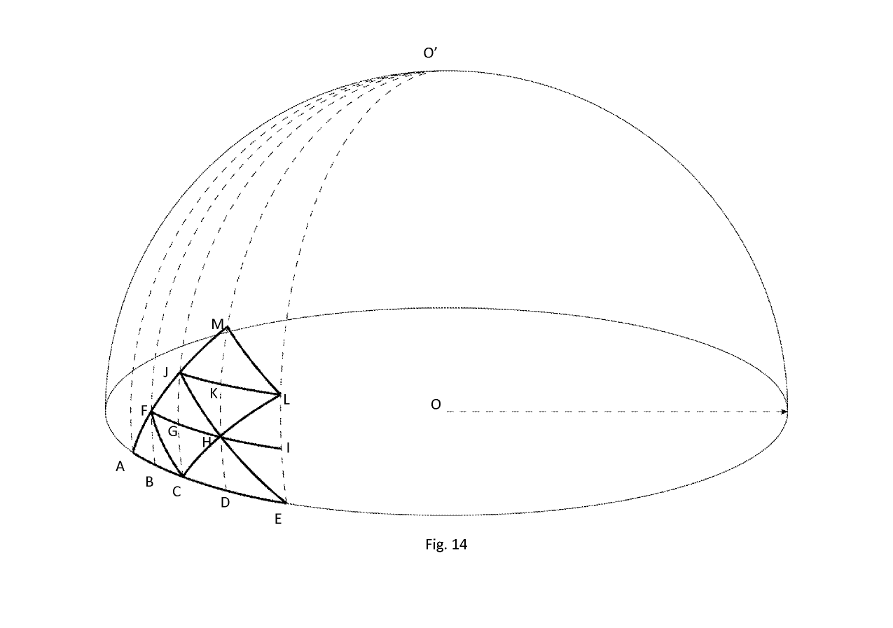

According to an embodiment, units of different levels of a dome structure share common characteristics, that is, the units for a dome structure share the same internal radius and external radius of the dome structure. Therefore different levels of units are made from molds sharing the same first mold piece and second mold piece. FIG. 13 shows the spatial relations of units of the dome structure. A first mold piece 10 and a second mold piece 20 are hypothetically placed within the dotted lines, showing their presumed spatial arrangement to the molded units for the dome. In the embodiment, the first mold piece 10 and second mold piece 20 each comprises two spherical surfaces respectively conforming to a hypothetical sphere. In the embodiment, the first mold piece 10 has a first surface conforming to a hypothetical sphere with radius R1, and a second surface conforming to a hypothetical sphere with radius R2; the second mold piece 20 has a first surface conforming to a hypothetical sphere with radius R3, and a second surface conforming to a hypothetical sphere with radius R4, wherein O is the common sphere center for all the aforementioned hypothetical spheres. The depth (D) of the units for the dome structure, that is, the thickness of the dome, is then determined to be D=R3−R2.

As described herein, units of a dome structure have sizes that are level specific. In general, a lower level unit is generally larger in its dimension than an upper level unit. The units may be made using molds that are level specific or have level specific component such as level specific third mold piece. According to an embodiment, even on the same level of a dome structure as shown in FIG. 12, each level typically may comprise two types of units: equilateral spherical triangular units interconnected by isosceles spherical triangular units. According to FIG. 14, a dome structural made of spherical triangular units comprises first level equilateral spherical triangular units ΔAFC and ΔCHE; wherein L_{AC}=L_{AF}=L_{FC}=L_{CE}=L_{CH}=L_{HE}=L1; wherein L is the arc length between two end points, and L1 is the length of the sides of spherical triangular units ΔAFC and ΔCHE. When the circular plane of OAC is divided into m parts, then L1×m=2πr, wherein r is the radius of the circle at bottom of the dome structure. Additionally, L_{GC}=H1, wherein G is the middle point of the arc between two points F and H, and L is the arc length between G and C. When m and r are predetermined, then L1 may be derived from the above. Furthermore, H1 may be derived for the Isosceles triangular unit ΔCFH that is inversely positioned to the equilateral spherical triangular unit ΔAFC and ΔCHE. Similarly, on the second level of the dome structure, L_{JF}=L_{fH}=L_{HJ}=L2, wherein L is the arc length between two end points; and L2 is the length of the sides of spherical triangular units ΔJFH on the second level. Additionally, L_{HK}=H2, wherein K is the middle point of the arc between two points L and J, and L is the arc length between H and K. Similarly, on the third level of the dome structure, L_{JL}=L_{LM}=L_{MJ}=L3, wherein L is the arc length between two end points; and L3 is the length of the sides of spherical triangular units ΔMJL on the third level. Therefore, additional levels may be made comprising level specific units produced from mold, and specific sizes of each unit may be derived based on predetermined r, m and depth of each unit prior to manufacture.

A dome structure may have the benefit of lower consumption of construction materials, lower cost, higher enclosed space for use, higher structural strength and better safety. However, constructing a dome structure is difficult. Molds for pre-fabricated units of a dome structure solve the difficulty in constructing a dome bearing the perfect structural resemblance to a hemisphere. Units for dome structure may provide a wide range of applications in fields such as emergency shelters, building constructions or toys.

Molding material for the units of a dome structure may be selected based on the desired field of applications of the dome structure. According to an embodiment, a mold cavity is configured for receiving a molding material for making units of the dome structure. For example, when an application of the mold is in the field of toys, molding material may be a malleable substance used in building and sculpting, such as a type of rubber, a modelling clay that may comprise a ceramic clay, an oil-based clay such as plasticine, polymer clay polymer clay such as Fimo, Kato Polyclay, Sculpey, and Modello, plastics, paper clay, fibers or a combination thereof. Units made from such molding materials are to be used for purpose of education, training and exercise, or fun activity. Units made as such may be easily assembled by various means such as by using hot glue or double-sided tape.

In another example, when an application of the mold is in the field of making emergency shelters, molding material may be ice and snow, and the dome structure made is an igloo type structure. Units made from ice or snow may be assembled by stacking and filling the joining seams with snow.

In addition, when an application of the mold is in the field of industrial construction, molding material may be more durable materials such as metal, wood, foam material, plastics, cement, concrete, glass fiber, carbon fiber, or a combination thereof. The dome structure made thereof will be a more permanent type building. Units may be assembled according to industrial standard. It's also conceived that units may be joined furthermore by frames prefabricated for a dome structure.

According to an embodiment, the mold further comprises an injection hole for receiving a molding material into the mold cavity. An injection hole may be provided on any one of the first, second or third mold piece or on an additional part of the mold assembly.

According to an embodiment, the mold may be made of a variety type of materials, such as metal, wood, plastics, PVC, glass, foam material, carbon fiber etc. Preferably, the mold is made of low cost, durable and light weight material, for easy carry, use.

Although the mold described herein is provided as comprising a first, second and third mold piece, it is conceivable to one of ordinary skill in the art that the components may be combined or integrated into less number of pieces, or designed as more number of pieces, and all of which may still provide the same or similar functions as illustrated in the specification.

In relation to the claims, it is intended that when words such as “a,” “an,” “at least one,” or “at least one portion” are used to preface a feature there is no intention to limit the claim to only one such feature unless specifically stated to the contrary in the claim.

The descriptions above are intended to be illustrative, not limiting. Other embodiments, uses and advantages of the invention will be apparent to those skilled in the art from consideration of the specification and practice of the invention disclosed herein. The specification should be considered exemplary only, and the scope of the invention is accordingly intended to be limited only by the following claims.

What is claimed is:

1. A mold for making units of a dome structure, comprising:
a first mold piece, a second mold piece, a third mold piece;
wherein the third mold piece is configured to be sandwiched between and assembled with the first and second mold pieces;
wherein an assembly of the first mold piece, the second mold piece, and the third mold piece is configured to form a mold cavity;
wherein the third mold piece comprises a plurality of sidewall plates;
wherein the plurality of sidewall plates are perpendicular to a same spherical surface when the third mold piece is assembled with the first and second mold pieces.

2. The mold of claim 1, wherein the first mold piece comprises a first spherical surface.

3. The mold of claim 2, wherein each of the plurality of sidewall plates comprises an end surface conforming to the first spherical surface.

4. The mold of claim 1, wherein the second mold piece comprises a second spherical surface.

5. The mold of claim 4, wherein each of the plurality of sidewall plates comprises an end surface conforming to the second spherical surface.

6. The mold of claim 1, wherein a cross section of the mold cavity is an equilateral triangle in shape.

7. The mold of claim 1, wherein a cross section of the mold cavity is a triangle in shape.

8. The mold of claim 1, wherein a cross section of the mold cavity is isosceles trapezoid in shape.

9. The mold of claim 1, wherein the third mold piece comprises three or more sidewall plates.

10. The mold of claim 1, further comprising a plurality of fasteners configured to join the plurality of sidewall plates with each other.

11. The mold of claim 1, further comprising a plurality of fasteners configured to join the plurality of sidewall plates with the first mold piece or second mold piece to form the mold cavity.

12. The mold of claim 1, wherein the plurality of sidewall plates comprise a plurality of through holes.

13. The mold of claim 1, wherein the second mold piece comprises a plurality positioning holes for joining with the third mold piece.

14. The mold of claim 13, wherein the plurality positioning holes comprises a first group of four positioning holes that are on a first minor arc of a first great circle of the second spherical surface.

15. The mold of claim 14, wherein the plurality positioning holes comprises a second group of two positioning holes that are on a second minor arc of a second great circle of the second spherical surface.

16. The mold of claim 1, further comprising a base that is configured to support an assembly of the first, second and third mold piece.

17. The mold of claim 1, wherein the mold cavity is configured for receiving a molding material for making units of the dome structure.

18. The mold of claim 1, further comprising an injection hole for receiving a molding material into the mold cavity.

19. A method of using the mold of claim 1, wherein the method comprising:
assembling the plurality of sidewall plates to form the third mold piece;
assembling the second mold piece and the third mold piece;
assembling the first mold piece with the second mold piece and the third mold piece to form the mold cavity of a first-level mold;
injecting a molding material into the mold cavity;
forming a unit of a first-level dome structure by allowing the molding material to form into shape;
opening the first-level mold;
extracting the unit of the first-level dome structure.

20. A method of making units of a dome structure using a set of molds, wherein each set of molds are configured for making units of the dome structure; wherein the set of molds comprises a first-level mold;
wherein the first-level mold comprises a first mold piece, a second mold piece, and a third mold piece;
wherein the third mold piece is configured to be sandwiched between and assembled with the first and second mold pieces;
wherein the third mold piece comprises a plurality of sidewall plates;
wherein the plurality of sidewall plates are perpendicular to a same spherical surface when the third mold piece is assembled with the first and second mold pieces;
wherein the first-level mold comprises an injection hole for receiving a molding material into the mold cavity;
the method comprising:
assembling the plurality of sidewall plates to form the third mold piece;
assembling the second mold piece and the third mold piece;
assembling the first mold piece with the second mold piece and the third mold piece to form the mold cavity of the first-level mold;
injecting the molding material into the mold cavity;
forming a unit of a first-level dome structure by allowing the molding material to form into shape;
opening the first-level mold;
extracting the unit of a first-level dome structure.
